(19) United States
(12) Patent Application Publication
(10) Pub. No.: US 2021/0219785 A1
(43) Pub. Date: Jul. 22, 2021

(54) FOODSTUFF CONTAINER AND AGITATOR

(71) Applicant: Viva 5 Group, LLC, Parkland, FL (US)

(72) Inventor: Joseph Todd Hansley, Glendale, CO (US)

(21) Appl. No.: 17/220,490

(22) Filed: Apr. 1, 2021

Related U.S. Application Data
(63) Continuation-in-part of application No. 16/019,445, filed on Jun. 26, 2018.

(30) Foreign Application Priority Data
Apr. 2, 2020 (CN) 202030124266
Apr. 2, 2020 (CN) 202030124268

(51) Int. Cl. A47J 43/27; B01F 13/00; B01F 15/00

(52) U.S. Cl. CPC A47J 43/27; B01F 13/0022; B01F 2215/0022; B01F 15/00512; B01F 13/005

(57) ABSTRACT

A mixing device includes a container and an agitator. The container includes cavity, a spout, and a lid. The agitator is retained within the cavity of the container. The agitator includes a core having opposing first and second ends, a plurality of alternating slots and slats in the first end of the core, and a plurality of alternating slots and slats in the second end of the core. The agitator also includes a ring extending circumferentially about the core, a first plurality of braces extending between the slats at the first end of the core and the ring, and a second plurality of braces extending between the slats at the second end of the core and the ring.

### CROSS-REFERENCE TO RELATED APPLICATIONS

This application is a continuation in part of: (i) U.S. patent application Ser. No. 16/019,445, filed Jun. 26, 2018, and entitled VESSEL WITH AGITATOR, (ii) Chinese Patent Application No. 202030124268, filed Apr. 2, 2020, and (iii) Chinese Patent Application No. 202030124266, filed Apr. 2, 2020. Each of the foregoing patent applications is incorporated herein by reference in its entirety.

### 1. TECHNICAL FIELD

The present disclosure generally relates to foodstuffs containers and agitators. More specifically, the present disclosure relates to a foodstuff container having an agitator therein for mixing dry and liquid ingredients.

### 2. RELATED TECHNOLOGY

As consumer's lives become busier and more active, the need and desire to take in adequate nutrition on-the-go has increased. The use of supplements to ensure proper nutrition has become increasingly popular. Some of these supplements are distributed in the form of a bulk powder, such as protein, that can be mixed with liquids (e.g., water) to form a drinkable mixture.

The population has become increasingly aware of the need to consumer adequate levels of various supplements, including protein, as well as the timing related to the consumption of such supplements. As a result, consumers have a desire to carry their supplements with them throughout the day. However, such supplements are often sold in 1-5 pounds containers, which are bulky and inconvenient or impractical to carry throughout the day.

Some consumers have devised other ways of transporting their daily requirement of powder supplements. For instance, some consumers dispense a serving of the powder supplement into a smaller bottle that can be more easily carried throughout the day. While such efforts allow for the powder supplements to be more easily transported, consumers often still face the challenge of adequately mixing the powder supplement with a liquid at the time of consumption.

### BRIEF SUMMARY

In one exemplary embodiment, a mixing device is provided. The mixing device includes a container and an agitator. The container includes first and second opposing sidewalls that define a cavity therebetween, a spout having a channel therethrough, the channel being configured to provide ingress and egress of material into and out of the cavity, and a selectively operable lid engageable with the spout. The agitator is retained within the cavity of the container. The agitator includes a generally spherical shape with opposing first and second poles, a core extending between the opposing first and second poles, the core having a first end and an opposing second end, a ring extending circumferentially about the core, a first plurality of braces extending between the first end of the core and the ring, and a second plurality of braces extending between the second end of the core and the ring.

According to another embodiment, a mixing device includes a container and an agitator. The container includes cavity, a spout, and a lid. The agitator includes a core having opposing first and second ends, a plurality of alternating slots and slats in the first end of the core, and a plurality of alternating slots and slats in the second end of the core. The agitator also includes a ring extending circumferentially about the core, a first plurality of braces extending between the slats at the first end of the core and the ring, and a second plurality of braces extending between the slats at the second end of the core and the ring.

In still another embodiment, an agitator is provided for use in mixing a powder with a liquid. The agitator includes a core comprising opposing first and second ends, a ring extending circumferentially about the core, a first plurality of braces extending between the first end of the core and the ring, and a second plurality of braces extending between the second end of the core and the ring.

These and other objects and features of the present disclosure will become more fully apparent from the following description and appended claims or may be learned by the practice of the disclosure as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a foodstuff container and agitator according to one embodiment of the present disclosure.

FIG. 2 illustrates a top perspective view of the agitator of FIG. 1.

FIG. 3 illustrates another top perspective view of the agitator of FIG. 1.

FIG. 4 illustrates a bottom perspective view of the agitator of FIG. 1.

FIG. 5 illustrates a first side elevational view of the agitator of FIG. 1.

FIG. 6 illustrates a second side elevational view of the agitator of FIG. 1.

FIG. 7 illustrates a top plan view of the agitator of FIG. 1.

FIG. 8 illustrates a bottom plan view of the agitator of FIG. 1.

FIG. 9 illustrates a third side elevational view of the agitator of FIG. 1.

FIG. 10 illustrates a fourth side elevational view of the agitator of FIG. 1.

### DETAILED DESCRIPTION

While the present disclosure will describe details of embodiments with reference to specific configurations, the descriptions are illustrative and are not to be construed as limiting the scope of the present invention. Various modifications can be made to the illustrated configurations without departing from the spirit and scope of the invention as defined by the claims. For better understanding, like components have been designated by like reference numbers throughout the various accompanying figures.

In general, the disclosed embodiments relate to a foodstuff container with an agitator disposed within a cavity of the container. The container may contain a foodstuff in the cavity, such as a powder supplement. A liquid, such as water, may be added to the cavity. The container may then be shaken to mix the liquid and foodstuff together. The agitator in the cavity may help brake up clumps of the foodstuff and facilitate mixing of the liquid and foodstuff.

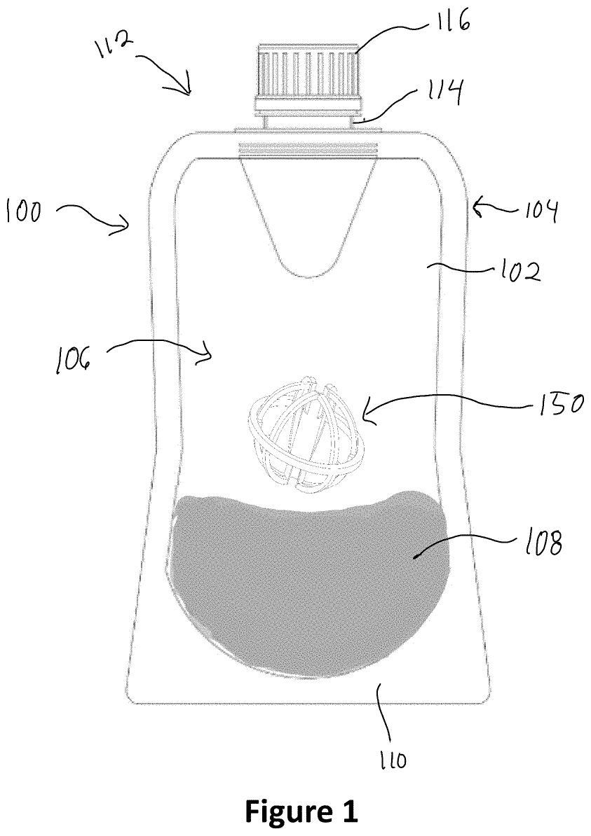

FIG. 1 illustrates one example embodiment of a foodstuff container 100 with an agitator 150 disposed therein. The container 100 may have first and second opposing sidewall 102, 104 that are sealingly engaged around all or most of the perimeter of the container 100. Each sidewall 102, 104, when engaged with one another, forms a cavity 106 therebetween. The cavity 106 may have foodstuff 108, the agitator 150, and a liquid disposed therein. The container 100 has a sealed bottom end 110 and a top end 112. The top end 112 includes a spout 114 and a lid 116. The lid 116 can be selectively secured onto or removed from the spout 114. The spout 114 includes a channel therethrough. With the lid 116 removed from the spout 114, the foodstuff 108 and/or a liquid may be introduced into the cavity 106 of the container 100 through the channel in the spout 114. With the foodstuff 108 and liquid in the cavity 106, the lid 116 can be secured onto the spout 114. The lid 116 can close or otherwise seal off the channel in the spout 114, thereby limiting or preventing the foodstuff and/or liquid from exiting the cavity 106 through the spout 114. The container 100 may then be shaken to mix the foodstuff 108 and the liquid together. As noted, the agitator 150 may facilitate a more uniform and complete mixing of the foodstuff and the liquid.

In some embodiments, the container 100 acts as a storage container for the foodstuff 108, such as a powdered protein supplement. During production, the foodstuff 108 is stored within the container 100 such that the foodstuff composition is preserved under similar conditions as in various packaging standards known in the art. The container 100 with the foodstuff 108 therein may be provided to the user as one of a set or kit, to provide a sufficient serving of the foodstuff 108 based off of standard serving sizes. For instance, in some embodiments, the container 100 is adapted to retain between 5 grams and 100 grams of the foodstuff 108.

The channel through the spout 114 and the agitator 150 may be sized such that the agitator 150 is not able to pass through the channel. This will ensure that a user will not ingest the agitator 150, as the agitator 150 will remain in the container 100. To dispose the agitator 150 in the container 100, the agitator 150 may be positioned between the opposing sidewalls 102, 104 prior to the edges thereof being attached together. Alternatively, the edges of the opposing sidewalls 102, 104 may be attached together along the bottoms and sides thereof, but not along a portion of the tops thereof. The agitator 150 may then be inserted into the cavity 106 through the opening between the tops of the opposing sidewalls 102, 104. Thereafter, the spout 114 may be inserted into the opening between the tops of the tops of the opposing sidewalls 102, 104, The opposing sidewalls 102, 104 may then be secured and sealed around the spout 114.

In some embodiments, the spout 114 and the lid 116 may include mating threads to permit the lid 116 to be selectively secured onto or removed from the spout 114. When the lid 116 is secured onto the spout 114, the lid 116 may limit or prevent the foodstuff 108 or liquid in the container 100 from exiting therefrom through the channel in the spout 114. On the other hand, when the lid 116 is removed, the foodstuff 108 and/or liquid may be added to the container or the mixture of the foodstuff 108 and liquid may be extracted from or poured out of the container 100 through the channel in the spout 114. In some embodiments, the lid 116 is provided as a sealed component to ensure a hermetic seal of the container 100. The lid 116 may be sealed to the spout 114.

In some embodiments, the container 100 is intended to be used as a single-use mixing vessel. In some embodiments, the container may be comprised of opaque, light reflecting, heat reflecting, or otherwise element-impermeable materials to promote a longer shelf life of the foodstuffs 108 stored therein. In some embodiments, the material used to form the container 100 may be a flexible material that permits the user to easily transport the container 100 in a pocket, backpack, gym bag, or similar area while absorbing impact and reducing detriment to the container 100.

While many embodiments exist, the foodstuff 108 may include a supplement powder, a protein powder, a meal replacement powder, a medicament, a vitamin mixture, or other dissolvable foodstuff. Other uses may include the mixing of eggs, paint, salad dressings, solid suspensions, viscous fluids, and other food, nonfood, or fluid products.

As alluded to elsewhere herein, it is common that certain powder materials do not readily mix with water or other liquids to form a solution or a uniform solution. For example, protein powder typically needs to be agitated to form a mixture or uniform mixture with water, milk, and other commonly used fluids. The agitator 150 is designed to agitate the foodstuff 108 so that the foodstuff 108 and a liquid form a desirable and palatable mixture of the powder foodstuff 108 and the liquid.

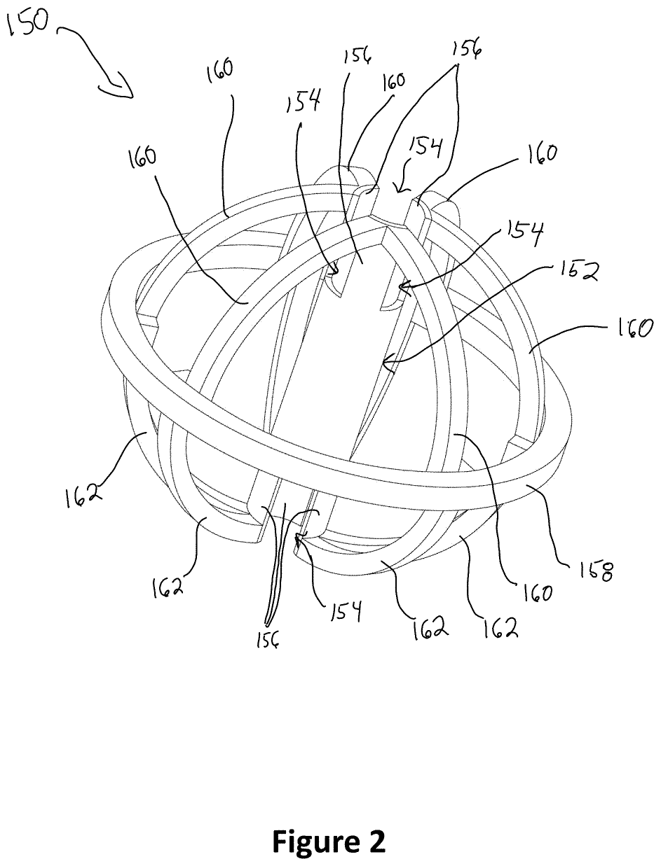

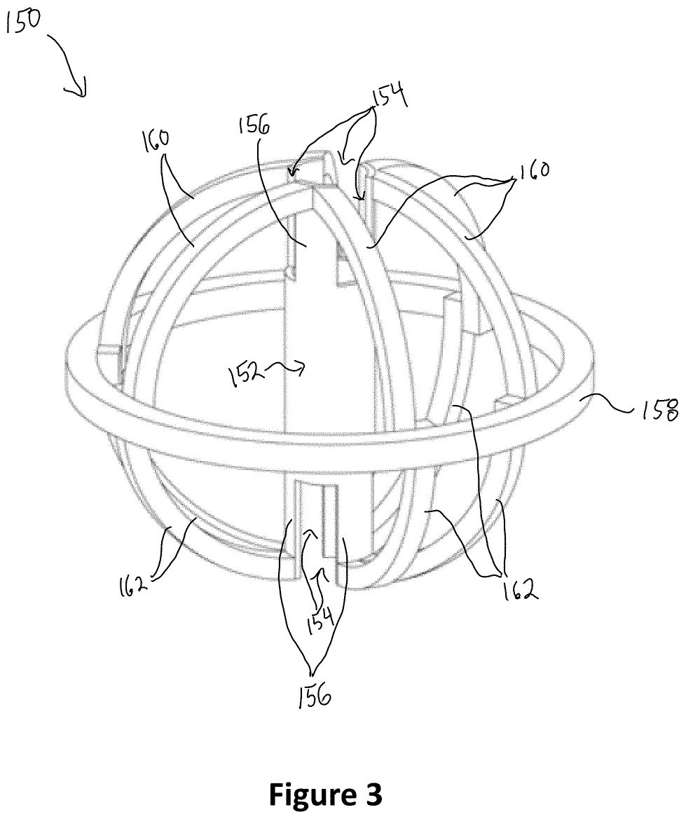

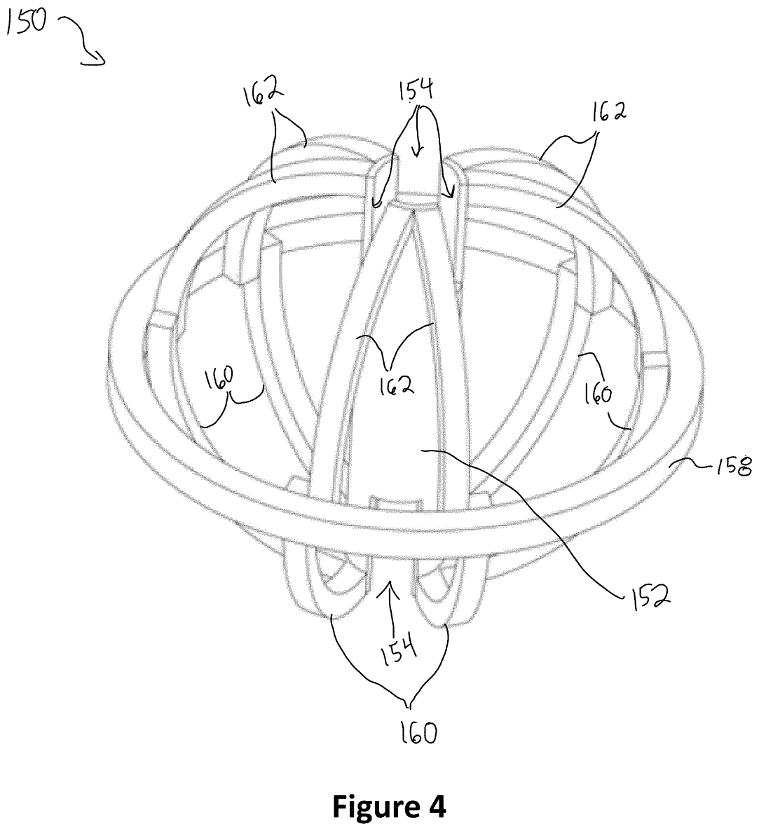

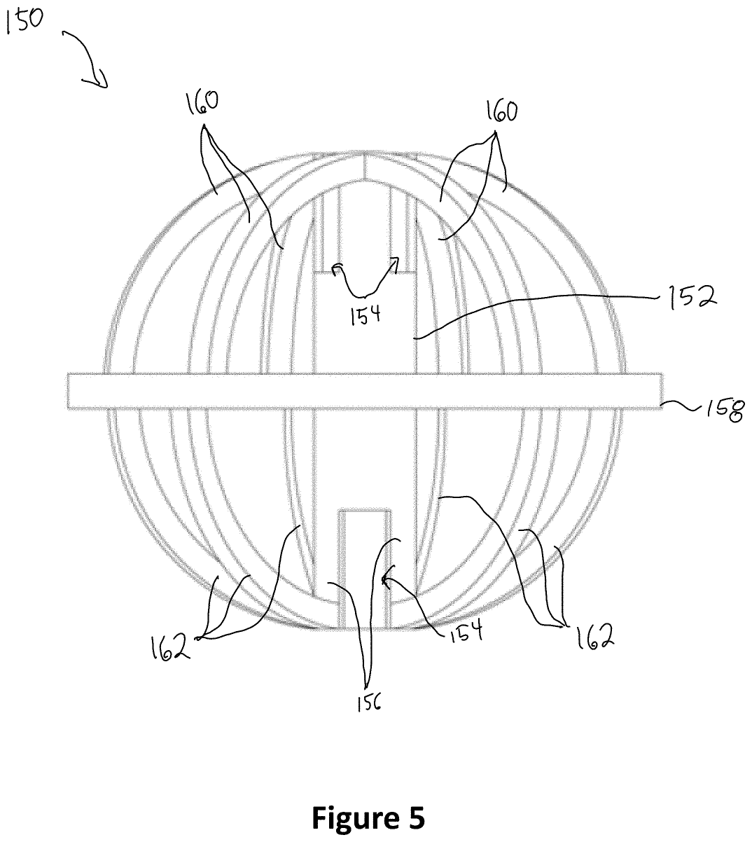

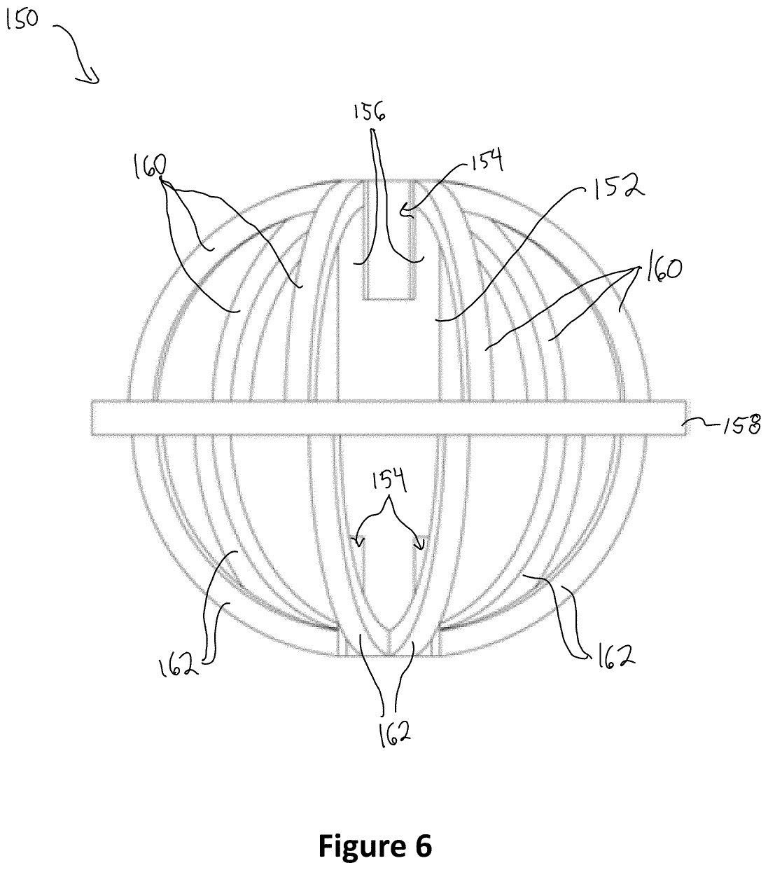

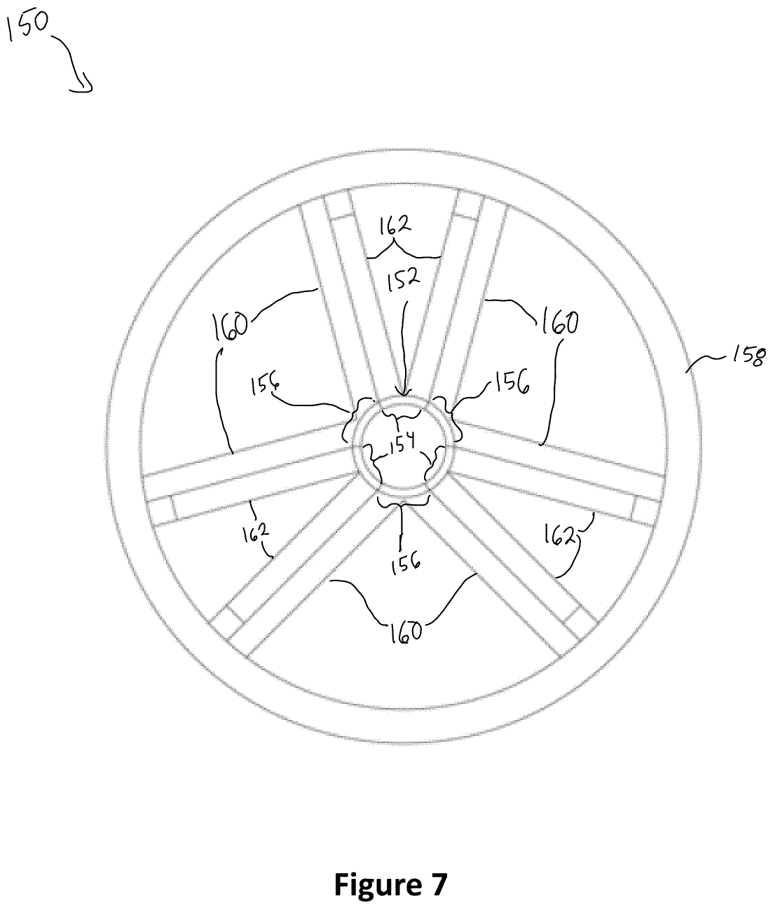

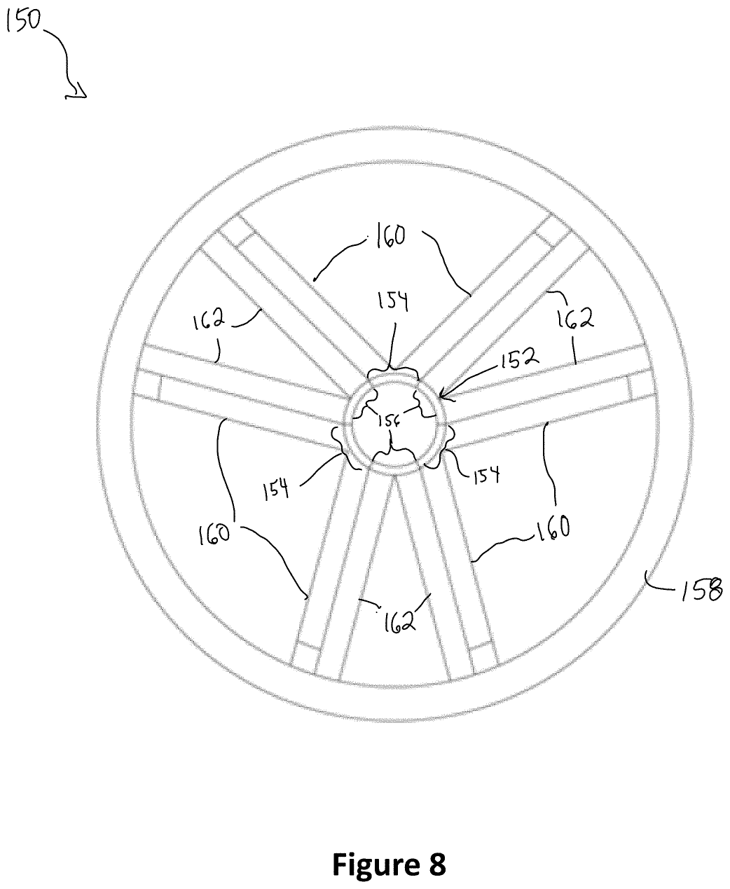

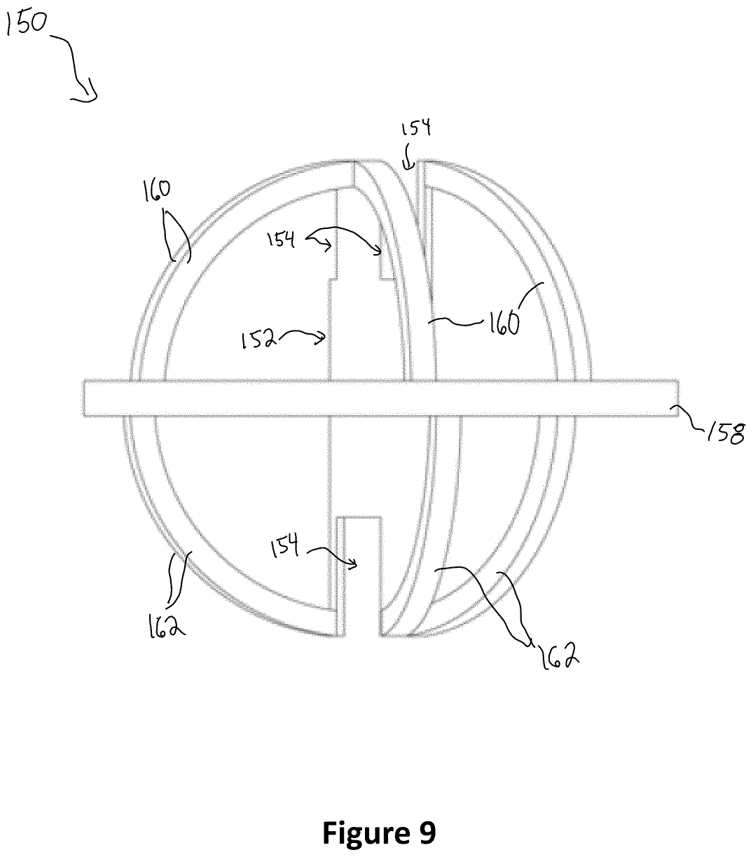

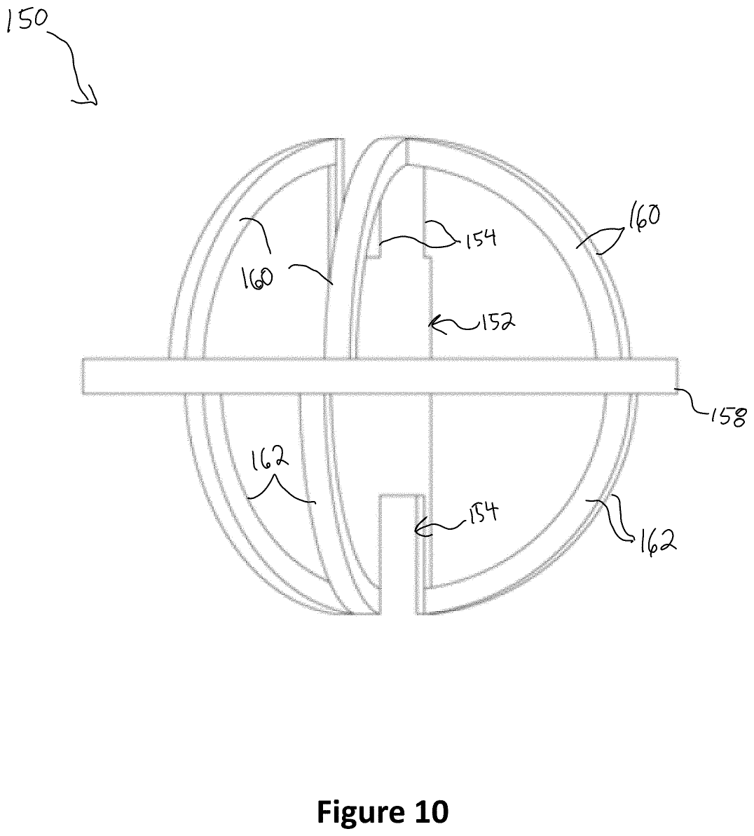

Attention is now directed to FIGS. 2-10, which illustrate the agitator 150 according to an example embodiment of the present disclosure. In the illustrated embodiment, the agitator 150 has a generally spherical shape and is constructed to forcibly contact the interior of the cavity 106 and the foodstuff 108 during agitation (e.g., shaking of the container 100). Although the agitator 150 is illustrated as being generally spherical in shape, it will be appreciated that the agitator 150 may have other general shapes, including ovoid, cuboid, octahedron, and the like.

In the illustrate embodiment, the agitator 150 includes a core 152. The core 152 may extend between opposing poles of the agitator 150. The core 152 may have a generally cylindrical shape as show in the figures. In some embodiments, the core 152 has a hollow interior that opens to opposing ends thereof, thereby providing a channel through the length of the core 152.

Furthermore, as shown in the Figures, the core 152 may include one or more slots 154 extending along a portion of the length thereof and between interior and exterior surfaces thereof. According to the illustrated embodiment, the core includes three slots 154 adjacent each end thereof, however, the core 152 may include fewer or more than three slots 154. In the illustrated embodiment, the slots 154 at each end of the core 152 are circumferentially spaced apart around the core 152. For instance, the slots 154 may be circumferentially offset from one another by about 120 degrees. While the slots 156 are shown as being evenly spaced about the core 152, the slots 156 may have nonuniform or uneven spacing around the core 152.

The portions of the core 152 disposed between the slots 154 may be referred to at slats 156. As with the slots 154, the slats 156 may be evenly or unevenly spaced about the circumference of the core 152. Furthermore, the slots 154 and/or the slats 156 may have substantially equal circumferential dimensions or the slots 154 and/or slats 156 may have dimensions that are not all equal to one another.

As can be seen best in FIGS. 2, 5, and 6, the slots 154 in one end of the core 152 may be, at least partially, circumferentially offset from the slots 154 in the other end of the core 152. Similarly, the slats 156 in one end of the core 152 may be, at least partially, circumferentially offset from the slats 156 in the other end of the core 152. In some embodiments, the slots 154 in one end of the core 152 are aligned with the slats 156 in the other end of the core, and vice versa.

In the illustrated embodiment, the agitator 150 includes a ring 158. The ring 158 may be dispose about halfway between the opposing ends of the core 152. The ring 158 is connected to the core 152 by a plurality of first braces 160 and a plurality of second braces 162. Each of the braces 160, 162 has a generally arcuate shape. The first braces 160 extend between the slats 156 at one end of the core 152 and the ring 158. Similarly, the second braces 162 extend between the slats 156 at a second end of the core 152 and the ring 158. In some embodiments, the braces 160, 162 are connected to the core 152 and/or the ring 158 with a fastener (e.g., pin, adhesive, etc.), a friction connection, or a bonding process. In other embodiments, one or more of the braces 160, 162 may be integrally formed with the core 152 and/or the ring 158.

The braces 160, 162 may be arranged in pairs. For instance, each brace 160 may have a corresponding brace 162. In some embodiments, the pairs of braces 160,162 may be circumferentially aligned with one another. That is, a brace 160 may be circumferentially aligned with a brace 162 such that the ends of the braces 160, 162 connect to one another at and/or circumferentially at the same location on the ring 158. In other embodiments, such as that shown in the figures, each the paired braces 160, 162 may be circumferentially offset from one another. For instance, one of the braces 160 may extend between a slat 156 at one end of the core 152 and the ring 158. A paired brace 162 may extend between the ring 158 and a slat 156 at the other end of the core 152. Because the slats 156 at the opposing ends of the core 152 are circumferentially offset from one another, the paired braces 160, 162 are also circumferentially offset from one another.

As best seen in FIGS. 2, 4, 7, and 8, the illustrated embodiment includes six first braces 160 and six second braces 162. The six first braces 160 are arranged in pairs and the six second braces 162 are arranged in pairs. For instance, each of the slats 156 at the first end of the core 152 has two, or a paired set, of the first braces 160 connected thereto. Similarly, each of the slats 156 at the second end of the core 152 has two, or a paired set, of the second braces 160 connected thereto.

In the illustrated embodiment, the ring 158 and braces 160, 162 each has a rectangular cross-sectional shape. However, this is merely exemplary. In other embodiments, the ring 158, braces 160, and/or braces 162 may have other cross-sectional shapes, such as circular, oval, star, or the like.

Unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

The present invention may be embodied in other specific forms without departing from its spirit or essential characteristics. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A mixing device comprising:
a container comprising:
first and second opposing sidewalls that define a cavity therebetween;
a spout having a channel therethrough, the channel being configured to provide ingress and egress of material into and out of the cavity; and
a selectively operable lid engageable with the spout; and
an agitator retained within the cavity of the container, the agitator comprising:
a generally spherical shape with opposing first and second poles;
a core extending between the opposing first and second poles, the core having a first end and an opposing second end;
a ring extending circumferentially about the core;
a first plurality of braces extending between the first end of the core and the ring; and
a second plurality of braces extending between the second end of the core and the ring.

2. The device of claim 1, wherein the core comprises one or more slots disposed at the first end thereof.

3. The device of claim 2, wherein the one or more slots comprise three slots evenly distributed about a circumference of the core.

4. The device of claim 3, wherein the first end of the core comprises three slats disposed between the three slots.

5. The device of claim 4, wherein the first plurality of braces extend between the three slats at the first end of the core and the ring.

6. The device of claim 1, wherein the core comprises one or more slots disposed at the second end thereof.

7. The device of claim 6, wherein the one or more slots comprise three slots evenly distributed about a circumference of the core.

8. The device of claim 7, wherein the second end of the core comprises three slats disposed between the three slots.

9. The device of claim 8, wherein the second plurality of braces extend between the three slats at the second end of the core and the ring.

10. A mixing device comprising:
a container comprising cavity, a spout, and a lid; and
an agitator retained within the cavity of the container, the agitator comprising:
a core comprising:
opposing first and second ends;
a plurality of alternating slots and slats in the first end of the core; and
a plurality of alternating slots and slats in the second end of the core;
a ring extending circumferentially about the core;
a first plurality of braces extending between the slats at the first end of the core and the ring; and
a second plurality of braces extending between the slats at the second end of the core and the ring.

11. The device of claim 10, wherein the slats in the first end of the core are circumferentially offset from the slats in the second end of the core and the slots in the first end of the core are circumferentially offset from the slots in the second end of the core.

12. The device of claim 10, wherein the first plurality of braces are circumferentially offset from the second plurality of braces.

13. The device of claim 10, wherein the ring is disposed at about a midway point between the first end second ends of the core.

14. The device of claim 10, wherein the slats and slots are evenly spaced about the circumference of the core.

15. The device of claim 10, where that core has a channel extending therethrough between the first and second ends thereof.

16. An agitator for use in mixing a powder with a liquid, the agitator comprising:
a core comprising opposing first and second ends;
a ring extending circumferentially about the core;
a first plurality of braces extending between the first end of the core and the ring; and
a second plurality of braces extending between the second end of the core and the ring.

17. The agitator of claim 16, wherein the core comprises a plurality of alternating slots and slats circumferentially distributed about the first end of the core and a plurality of alternating slots and slats circumferentially distributed about the second end of the core.

18. The agitator of claim 17, wherein the slots in the first end of the core are aligned with the slats at the second end of the core.

19. The agitator of claim 16, wherein the first plurality of braces are circumferentially offset from the second plurality of braces.

20. The agitator of claim 16, wherein the ring is disposed at about a midway point between the first end second ends of the core.
